(19) United States
(12) Patent Application Publication
(10) Pub. No.: US 2010/0274887 A1
(43) Pub. Date: Oct. 28, 2010

(54) System and Method for Recommending Personalized Identifiers

(75) Inventor: Mehul Sanghavi, Sunnyvale, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/429,950

(22) Filed: Apr. 24, 2009

(51) Int. Cl. G06F 15/173

(52) U.S. Cl. 709/224

(57) ABSTRACT

Methods, systems and computer program products for providing one or more personalized identifiers to a user. In one method, the method obtains the user's personal information and user interest information from the user. The method generates a list of candidate identifiers taking into account the personal information or the user interest information. The method checks availability of the list of candidate identifiers using a database. The method provides a list of available identifiers to the user.

### TECHNICAL FIELD

The present disclosure generally relates to generating recommendations of personalized identifiers for users of network services.

### BACKGROUND

The World Wide Web has steadily evolved to offer a multitude of network applications that provide services catering to a wide range of user requirements. Some examples of such services are e-mail, instant messaging, social networking, content sharing, online gaming, online communities, and forums. Such services often associate one or more unique identifier(s) to their users for purposes such as, but not limited to, user authentication, user identification, providing a screen name or an email address to the user, and the like. In most instances, the users select their unique identifier(s) either when they register for a service or later, for example, when they create a new avatar, profile, or chat name. Once an identifier is associated with one user it becomes unavailable, in other words another user cannot use it.

Over the years, the number of users of these services has grown and many unique identifiers are already associated with existing users of these services and are therefore unavailable. Notably, many services are free of charge, and often users register for a service but later discontinue use. Therefore, a number of identifiers, particularly the more desirable or popular ones, become unavailable. As a result, quite often, an identifier desired by a user is unavailable because it is already in use.

To address this issue, a number of services suggest alternative identifiers to a user if the desired identifier is unavailable. However, such suggestions are usually less desirable and often cryptic. The suggested identifiers are often not personalized and they may not suit the user's profile, personality, or taste. In addition, where similar competing services are available, the unavailability of a desired identifier from one service operator may drive the user to switch to another service operator.

### SUMMARY

In particular embodiments, the present invention provides methods, systems and computer program products for providing one or more personalized identifiers to a user. In one method, the method obtains the user's personal information and user interest information from the user. The method generates a list of candidate identifiers taking into account the personal information or the user interest information. The method checks availability of the list of candidate identifiers using a database. The method provides a list of available identifiers to the user.

### BRIEF DESCRIPTION OF THE DRAWINGS

FIG. 1 illustrates an example network environment in which particular implementations may operate;

FIG. 2 is a flowchart illustrating an example method for generating one or more personalized identifiers;

FIG. 3 illustrates example rule sets for generating one or more personalized identifiers;

FIG. 4 is a flowchart illustrating an example process for obtaining a list of suggested identifiers from a user's contacts according to one embodiment;

FIG. 5 is a flowchart illustrating an example process for obtaining a list of suggested identifiers from the user's contacts according to one embodiment;

FIGS. 6A and 6B illustrate example user registration web pages according to one embodiment;

FIGS. 7A, 7B and 7C illustrate example user interfaces for the user's contacts for providing suggested identifiers according to one embodiment; and

FIG. 8 is a schematic diagram illustrating an example computing system for generating one or more personalized identifiers according to one embodiment.

### DETAILED DESCRIPTION

Various embodiments of the present invention will be described in detail below with reference to accompanying drawings. It will be apparent, however, that these embodiments may be practiced without some or all of these specific details. In other instances, well known process steps or elements have not been described in detail in order not to unnecessarily obscure the description of the invention. The following example embodiments and their aspects are described and illustrated in conjunction with apparatuses, methods, and systems which are meant to be illustrative examples, not limiting in scope.

Particular embodiments of the present invention provide systems and methods for providing one or more personalized identifiers for a user. The user may use the personalized identifiers for various applications such as, but without limitation, a login name for a network, an e-mail address, a screen name for instant messaging, an alias for an online game, and the like.

Example Network Environment

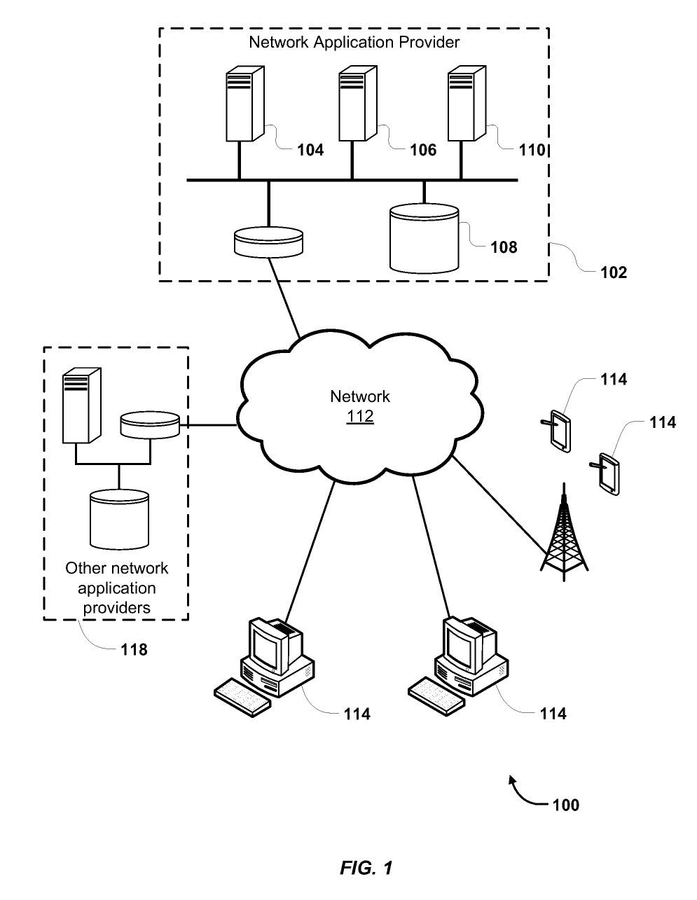

FIG. 1 illustrates an implementation of a network environment 100 in which a smart ID generator system may be deployed according to one embodiment. Network environment 100 includes a network application provider 102, a network 112, one or more client nodes 114, and one or more other network application providers 118. Network 112 generally represents one or more interconnected networks, over which network application provider 102, client nodes 114, and one or more other network application providers 118 can communicate with each other. Network 112 may include packet-based wide area networks (such as the Internet), local area networks (LAN), private networks, wireless networks, satellite networks, cellular networks, paging networks, and the like. A person skilled in the art will recognize that network 112 may also be a combination of more than one type of network. For example, network 112 may be a combination of a LAN and the Internet. In addition, network 112 may be implemented as a wired network, or a wireless network or a combination thereof. Client nodes 114 are communicatively coupled to network 112 via a network service provider or any other suitable methods known in the art. Similar to network application provider 102 of a particular application provider are one or more other network application providers 118. One or more other network application sites 118 are hosted by other application providers and may host the same or different type of network applications.

Network Application Provider

Network application provider 102 is a network addressable system that hosts a network application accessible to one or more users over network 112. The network application requires its users to identify themselves with at least one unique identifier. The network application may be, for example, an email service, an instant messaging service, a social network, a blog service, an online forum, a wiki service, a content distribution service or any other network application without limitation. In various embodiments of the present invention, network application provider 102 includes a registration and authentication server 104, a smart ID generator 106, a database 108 and one or more application servers 110.

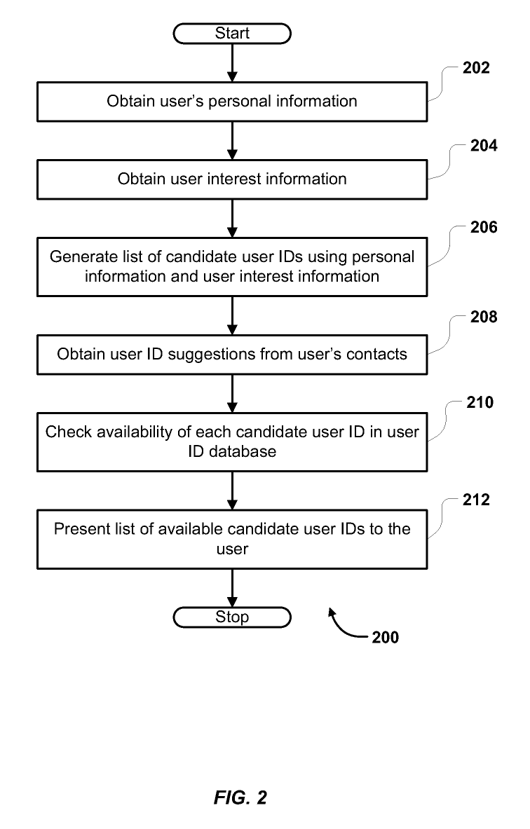

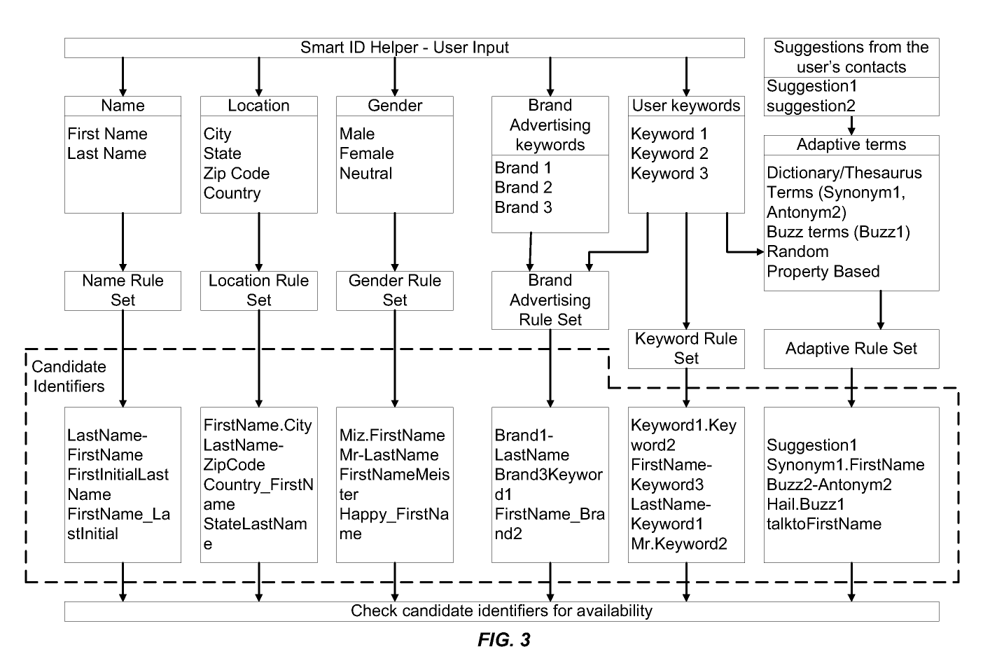

The registration and authentication server 104 facilitates registration of new users to the network application, and authenticates existing users at sign-in. In some embodiments, the registration and authentication server 104 uses security protocols such as Secure Sockets Layer (SSL), Transport Layer Security (TLS) or GnuTLS. Smart ID generator 106 recommends one or more personalized identifiers to a user when the user desires to acquire a unique identifier to access services provided by network application provider 102. Smart ID generator 106 may be invoked, for example, when network application provider 102 registers a new user or when an existing user of network application provider 102 wants to acquire a new identifier. The new identifier may be a user identity (ID), a screen name, an email address, an open ID Uniform Resource Locator (URL), an alias name and the like. Smart ID generator 106 receives personal information of the user, and user interest information from the user. The personal information includes, without limitation, a first name, a last name, a gender, a postal code and an address of the user. The user interest information includes, but is not limited to, one or more brand advertising keywords associated with the user's favorite brands, and/or one or more user specified keywords representing the user's interests and preferences. Smart ID generator 106 generates one or more candidate identifiers taking into account the personal information, and the user interest information. In various embodiments, the candidate identifiers may include parts of the personal information, parts of the user interest information, or both. For example, consider the case of generating candidate identifiers for a user named “John Doe” (i.e. personal information) who is interested in “Rock Music” (i.e. user interest information). The list of candidate identifiers for the user may include, for example, the identifiers “john” (based on a part of the personal information only), “rocker” (based on a part of the user interest information only), and “john.rocker” (based on parts of the personal information as well as the user interest information). Sample rule sets for generating candidate identifiers are discussed in further detail with reference to FIG. 3. Smart ID generator 106 further checks availability of the generated identifiers in database 108. Smart ID generator 106 may present the available identifiers as recommendations to the user. Various embodiments for generating the identifiers are explained in detail in conjunction with FIG. 2.

Database 108 stores information about the identifiers used by the existing users of the network application(s) hosted by network application provider 102. Information in database 108 may be used to check if a new identifier desired by a user is available. In an embodiment, database 108 maintains identifier availability information for one or more namespaces associated with different services provided by network application provider 102. A namespace for a service includes all unique identifiers that may be provisioned for use in conjunction with the service, wherein if a particular identifier is provisioned by a user of the service then it becomes ‘unavailable’ for use by any other user of the service. Database 108 may be implemented using any known database solution such as a Relational Database Management System (RDBMS), an Extensible Markup Language (XML) database, a flat file database, and the like. One or more application servers 110 host web pages and applications implemented using Common Gateway Interface script (CGI), PHP Hyper-text Processor (PHP), Active Server Pages (ASP), Hyper Text Markup Language (HTML), Extensible Markup Language (XML), Java and the like. Application servers 110 provide network application access to client nodes 114 after registration and authentication at registration and authentication server 104.

Client Nodes

Client node 114 is a computing device from which a user accesses the services provided by the network application provider 102. Client node 114 has the capability to communicate over network 112. Client node 114 further has the capability to provide the user an interface to interact with the service provided by network application provider 102. Client node 114 may be, for example, a desktop computer, a laptop computer, a mobile phone, a personal digital assistant, and the like. A client node may execute one or more client applications such as, without limitation, a web browser to access and view content over a computer network, an email client to send and retrieve emails and an instant messaging client for communicating with other users. Client nodes 114, in various embodiments, may include a Wireless Application Protocol (WAP) browser or other wireless or mobile device protocol suites such as, without limitation, NTT DoCoMo's i-mode wireless network service protocol suites, EDGE, and the like.

Other Network Application Providers

Similar to network application provider 102, are one or more other network application providers 118. Other network application providers 118 host the same or different type of network applications. Other network application providers 118 may include corresponding registration and authentication servers, application servers and databases. In one embodiment, the network application providers 118 store address books or lists of contacts for multiple users.

Although FIG. 1 illustrates the foregoing systems as separate systems, the functionality represented by each system may be combined into other systems. Furthermore, the functionality represented by each depicted system may be further separated. Still further, implementations of the present invention may operate in network environments that include multiples of one or more of the individual systems and sites disclosed herein. In addition, other implementations may operate in network environments where one or more of the systems described herein have been omitted.

Smart ID Generation

Smart ID generator 106 recommends one or more personalized identifiers to a new user when the new user begins a registration or a sign-up process with network application provider 102. In addition, smart ID generator 106 may also recommend one or more personalized identifiers to an existing user, when the existing user is subscribed to one or more network applications hosted by network application provider 102 and seeks a separate identifier for using these network applications or is subscribing to other network applications hosted by network application provider 102. For example, the existing user may already have an e-mail address and would like to sign-up for a chat application with a new identifier.

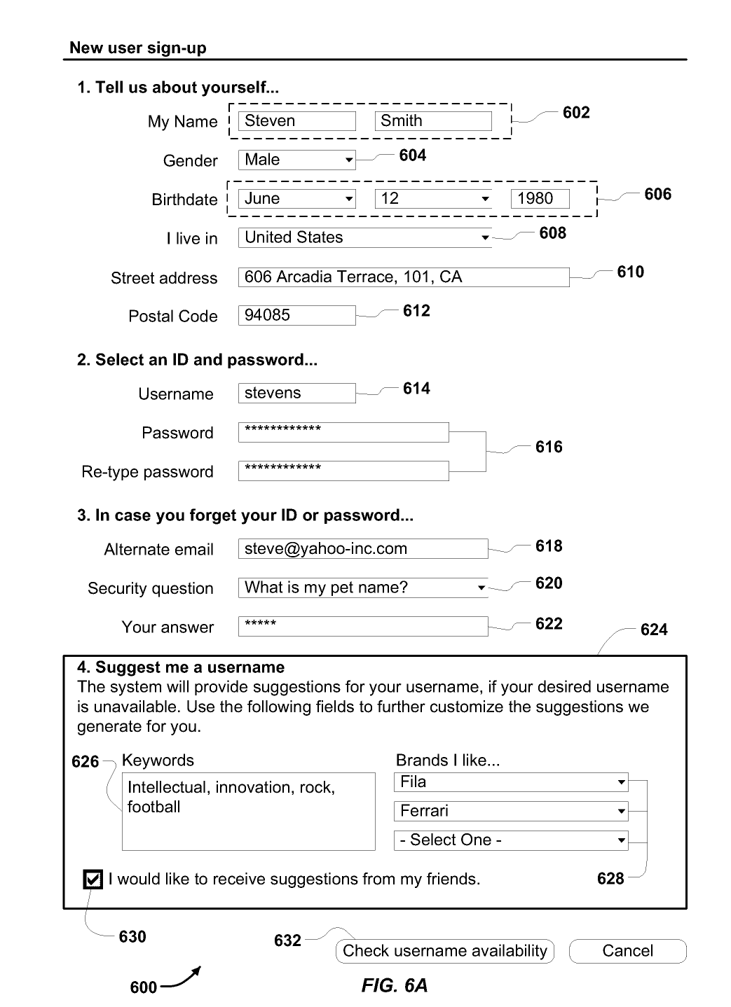

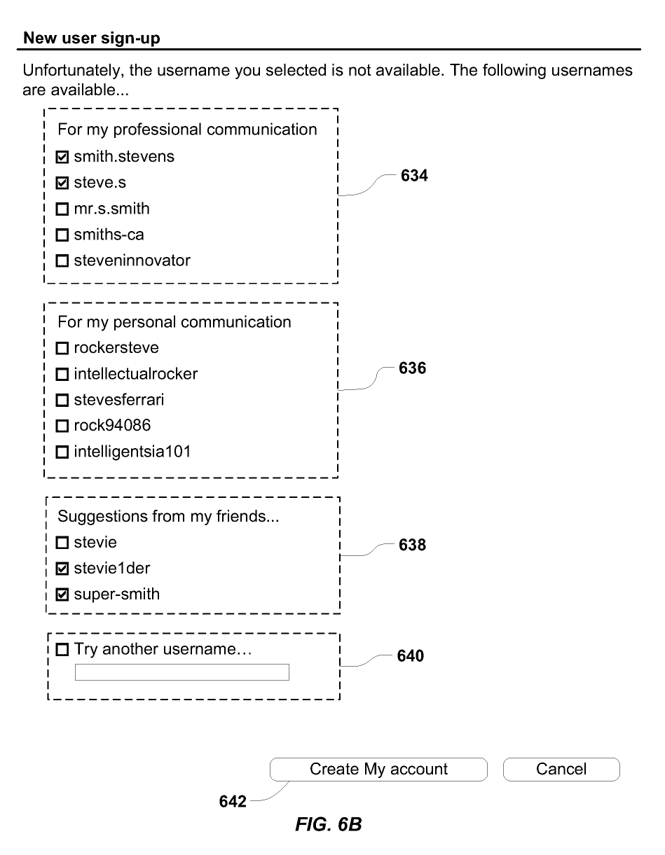

FIG. 2 illustrates an example process for recommending one or more personalized identifiers according to one embodiment. At step 202, smart ID generator 106 obtains the user's personal information. The user's personal information includes, but is not limited to, a first name, a last name, a gender, an address, and a postal code. The address may be a home address of the user or an office address of the user or both. In one embodiment, smart ID generator 106 presents a registration web page including a registration form having multiple fields to enable the user to submit the user's personal information. An example registration form is illustrated in FIGS. 6A and 6B. In another embodiment, smart ID generator 102 obtains the user's personal information from the other network application provider 118. At step 204, smart ID generator 106 obtains user interest information from the user's registration form. The user interest information includes, but is not limited to, one or more keywords specified by the user representing the user's interests, and/or one or more brand advertising keywords associated with the favorite brands of the user. The one or more keywords may include names of superheroes, keywords related to the user's hobbies, personality descriptive keywords (such as “adventurous”, “brutal”, “tranquil” etc.), nicknames, and so on. Examples of the brand advertising related keywords are “Nike”, “Ferrari”, “FIFA”, and so on. In one embodiment, smart ID generator 106 provides a list of predefined brand advertising keywords to the user in the registration form and the user selects one or more brand advertising keywords from this list. In another embodiment, smart ID generator 106 may allow the user to enter any brand advertising keywords of the user's choosing. A person skilled in the art will appreciate that the user specified keywords and the brand advertising keywords listed above are only for the purpose of providing illustrative examples and any other user specified keywords and brand advertising keywords representing the user's interests may be employed without deviating from the spirit and scope of the present invention.

At step 206, smart ID generator 106 generates one or more candidate identifiers taking into account the user's personal information and the user interest information. In various embodiments, the candidate identifiers may include parts of the personal information, parts of the user interest information, or both. Sample rule sets for generating candidate identifiers are discussed in further detail with reference to FIG. 3. In an embodiment, smart ID generator 106 applies one or more predetermined rules on the user's personal information and the user interest information. Example rule sets and candidate identifiers using these rule sets are described in conjunction with FIG. 3. In some embodiments, smart ID generator 106 may also use other characters, such as dot (•), underscore ( ), hyphen (-) etc., along with the personal information, the user interest information as well as the adaptive suggestions to generate candidate identifiers. In one embodiment, smart ID generator 106 also checks for forbidden or reserved words not allowed in identifiers by network application provider 102. Examples of the forbidden words are obscene, abusive or derogatory words. The reserved words may be, for example, “help”, “customerservice”, “register”, and the like.

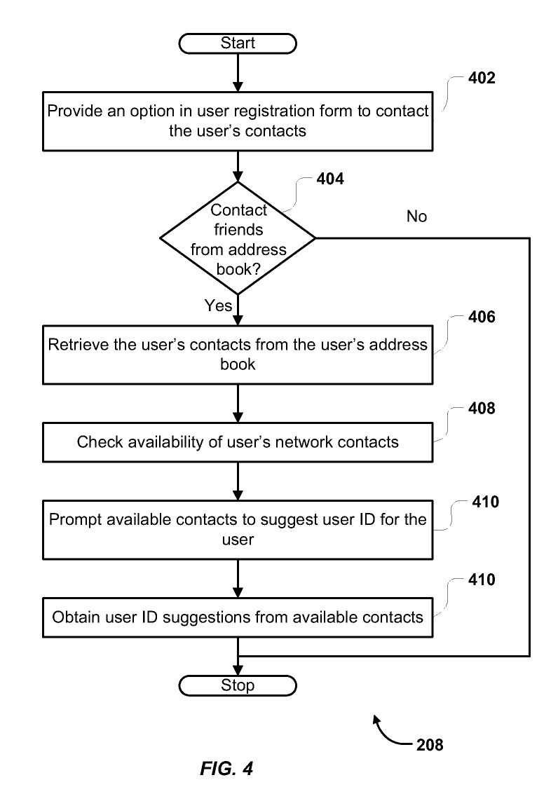

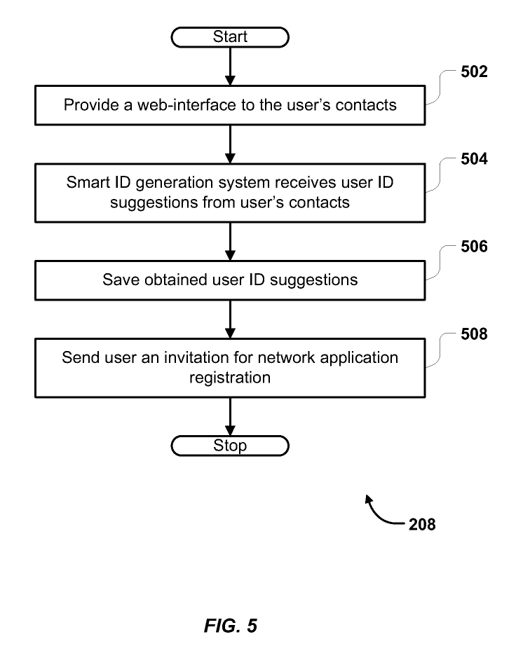

In addition to the candidate identifiers generated at step 206, smart ID generator 106 obtains suggested identifiers from one or more contacts of the user at step 208. The user's contacts may include friends, family, or acquaintances. The user's contacts may submit suggested identifiers using different ways, such as, without limitation, through an email, using a web interface or via an instant message. In some embodiments, the user's contacts may submit their suggestions during the user's registration process. An example process for obtaining suggested identifiers from the user's contacts during the user's registration process is explained in detail in conjunction with FIG. 4. Alternatively, in some embodiments, the user's contacts may send an invitation to the user to join the network application hosted at the network application provider 102. An example process for obtaining user IDs as suggestions from the user's contacts prior to the user's registration is explained in detail in conjunction with FIG. 5.

Smart ID generator 106 now has a list of candidate identifiers generated using the user's personal information and the user interest information, and a list of suggested identifiers received from the user's contacts. Further, method 200 may also generate a list of suggested identifiers using only the suggestions received from the user's contacts. In various embodiments, numerous such variations to method 200 may be made without deviating from the spirit and scope of the present invention. Accordingly, the terms “list of candidate identifiers” and “list of suggested identifiers” are used interchangeably in the specification to denote a collection of identifiers that smart ID generator 106 generates using the user's personal information and/or the user's interest information, as well as those that smart ID generator 106 receives as suggestions from the user's contacts/acquaintances.

At step 210, smart ID generator 106 checks each of the candidate identifiers and the suggested identifiers for availability, with existing identifiers stored in database 108. A list of available identifiers is then presented to the user at step 212. In one embodiment, the list of available identifiers is presented to the user on a separate web page. In another embodiment, each available identifier of the list of available identifiers is hyperlinked to a user ID provisioning script and presented to the user. The user simply clicks on the desired user ID hyperlink, thereby triggering the user ID provisioning script to complete the registration process. Furthermore, in various embodiments, smart ID generator 106 may cluster the list of available identifiers into one or more category clusters depending on type of application or use. For example, smart ID generator 106 may present separate lists of available identifiers for personal and professional use. The user may select one or more available identifiers for different network applications. Network application provider 102 then provisions the selected identifiers to the user for use with the network application and complete the registration process. In some embodiments, the selected identifiers may not be addressable via any communication protocols, for example, e-mail protocols, Session Initiation Protocol, or instant messaging protocols and hence, may not be provisioned for use with the network application. Possible network applications where the user may use such identifiers are online reviews, gaming alias and the like. In such cases, the user may select one identifier as a global identifier that is addressable via the communication protocols and the network application provider 102 links the global identifier to the user's other addressable and non-addressable identifiers and then provisions the global identifier. The knowledge of such linking of the selected identifiers to a global identifier may be stored with network application provider 102.

Example Rule Sets for Generating User ID Suggestions

FIG. 3 illustrates example rule sets for generating one or more personalized identifiers.

Name rule set: Smart ID generator 106 executes the Name Rule Set for generating candidate user IDs based, primarily, on the user's first name, or last name, or combinations thereof. Smart ID generator 106 may also consider the user's middle name for generating the candidate identifiers.

Location rule set: The Location Rule set uses the user's address, input as one or more of the postal code, a street, a city, a suburb, a state, and a country in addition to the user's name for generating the candidate identifiers. In some embodiments, where the user has not input an address, state of residence and city of residence, smart ID generator 106 may use geo-location techniques known in the art to derive the user's location from the zip code input and/or from the network address of the user's client device.

Gender rule set: Smart ID generator 106 executes the Gender Rule Set for generating candidate identifiers using the user's gender information and the user's name inputs. The gender rule set includes predetermined prefixes or suffixes to the user's name, such as “mr.” or “ms.”. The prefixes and the suffixes may be gender specific or gender neutral. The prefixes and the suffixes may also include terms from multiple languages, such as English, German, and Spanish etc., such as “herr” or “sensor”.

Keyword rule set: Smart ID generator 106 executes the Keyword rule set to generate candidate identifiers using the keywords provided by the user. The keywords may include names of superheroes, keywords related to the user's hobbies, personality descriptive keywords (such as “adventurous”, “brutal”, “tranquil” etc.), nicknames, and so on. In one embodiment, smart ID generator 106 generates candidate identifiers using combinations of the keywords. Exemplary candidate identifiers are “tranquilface” or “captainplanet-earth” or “brutal.pikey” and so on. In some embodiments, the keywords provided by the user may be directly used as candidate identifiers. In some embodiments, the Keyword Rule set may also use other user inputs such as the user's name or gender to generate candidate identifiers. Exemplary candidate identifiers are “adventurous-tom” or “smartalex” or “quick.nick” or “miss.pretty” and so on.

Brand advertising rule set: Smart ID generator 106 provides a predetermined set of brand advertising keywords as options to the user. The Brand Advertising rule set uses the predetermined set of brand advertising keywords along with the user's name as an option, to generate candidate user IDs. Examples of the brand advertising related keywords are “Nike”, “Ferrari”, “FIFA”, and so on. Exemplary candidate identifiers generated by smart ID generator 106 using the brand advertising rule set are “runner.nike” or “stevesferrari” or “fifa-fanatic-mike” and so on.

Adaptive rule set: The adaptive rule set generates variations of the keywords input by the user. The adaptive rule set may use dictionary or thesaurus variations such as synonyms, antonyms and related words related to the user specified keywords. For example, if the user inputs ‘music’ as a keyword, the adaptive rule set may use variations such as “musician”, “song”, “songbird” or “melody”, and the like to generate the candidate identifiers. The adaptive rule set may use buzz terms, that is, keywords based on popular search terms such as celebrities, current affairs figures, current news events, and so on. The adaptive rule set may also use predetermined property based prefixes or suffixes specific to the network application that the user wishes to register for. For example, if the user wishes to register for a chat service, the adaptive rule set may use a prefix such as “talkto”. In some embodiments, smart ID generator 106 may also be used by companies that offer business services to users of the network. In such cases, the adaptive rule set may use a suffix representing name or function of the companies or both when creating the candidate identifiers for customers of the companies. For example, if a company named “Acme” is providing plumbing services, then smart ID generator 106 may use a suffix “.acmeplumbling” in the candidate identifiers generated for customers of the company “Acme”. Such suffixes may be reserved by companies, using corporate registration or corporate subscription to the network application hosted by network application provider 102.

FIGS. 4 and 5 describe various embodiments for obtaining the list of suggested identifiers from the user's contacts. FIG. 4 illustrates a flowchart of an example implementation of step 208 for obtaining a list of suggested identifiers from the user's contacts according to one embodiment. At step 402, smart ID generator 106 provides an option in the user registration form to choose whether smart ID generator 106 can contact the user's contacts to obtain the list of suggested identifiers. At step 404, smart ID generator 106 checks whether the user has opted for contacting the user's contacts. If the user has opted for contacting the user's contacts smart ID generator 106 retrieves a list of user's contacts from the user's address book at step 406. In one embodiment, the user already has an existing subscription, for example an email account, with network application provider 102, and wishes to register for other network applications such as content sharing, media sharing, instant messaging, and the like. In this case, smart ID generator 106 retrieves the user's address book from the email account information stored on database 108. Smart ID generator 106 may or may not prompt the user for authentication before retrieving the user's address book. In another embodiment, the user is not registered with network application provider 102. In this case, the user may be required to select one or more other network application providers 118 with whom the user has email accounts. Smart ID generator 106 then prompts the user to authenticate access to the user's existing email accounts with selected one or more other network application providers 118. Upon authentication, smart ID generator 106 imports the user's address books from selected one or more other network application providers 118.

At step 408, smart ID generator 106 checks which of the user's contacts are available online at that time. In one embodiment, smart ID generator 106 accesses application server 110 to check whether any of the user's contact are online. Thereafter, smart ID generator 106 prompts the user's contacts that are available online, at step 410, to suggest one or more identifiers for the user. In one embodiment, smart ID generator 106 sends an instant message to the user's online contacts. The instant message may directly prompt the user's contacts to reply via an instant message containing suggestions for identifiers. Alternatively, smart ID generator 106 may send a hyperlink in the instant message to the user's online contacts with a hyperlink pointing to a web interface. In one embodiment, all of the user's online contacts are prompted for suggestions. In another embodiment, smart ID generator 106 offers an option to the user to select individual contacts or a group of contacts, for example, college friends group, to prompt for suggestions.

At step 412, smart ID generator 106 receives a list of suggested identifiers from the user's contacts. Depending on the mode of prompting the user's contacts to submit suggestions as described in conjunction with step 410, smart ID generator 106 receives the suggested identifiers either in an instant message, or through the web interface. It will be apparent to one skilled in the art that a number of other modes of prompting may be employed in conjunction with the present invention.

In some embodiments, the list of suggested identifiers may be obtained (step 208) before obtaining the user's personal information (step 202) and obtaining the user interest information (step 204). For example, the user's contacts registered with network application provider 102 may wish to invite the user to register for one or more network applications hosted by network application provider 102. A person skilled in the art will recognize other situations when the list of suggested identifiers may be obtained before obtaining the user's personal information and the user interest information.

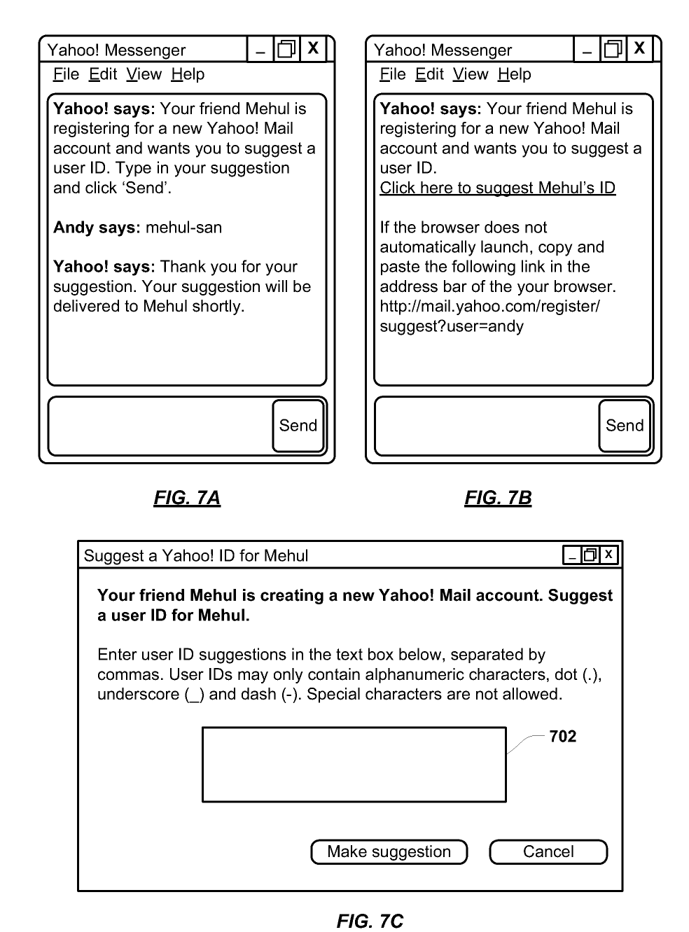

FIG. 5 illustrates a flowchart of an example implementation of step 208 for obtaining a list of suggested identifier from the user's contacts in such cases according to one embodiment. At step 502, smart ID generator 106 provides a web interface to the user's contacts. The web interface includes one or more fields where the user's contacts may enter suggested identifiers. In addition, the user's contacts may also be required to enter an e-mail address of the user. Depending on whether the user has an e-mail account with network application provider 102 or not, the e-mail address will either correspond to the one associated with network application provider 102 or with one of other network application providers 118. The user's contacts then submit the suggested identifiers through the web interface. An example implementation of such a web interface is described in conjunction with FIG. 7C.

At step 504, smart ID generator 106 receives the suggested identifiers from the user's contacts. Thereafter, at step 506, smart ID generator 106 saves the suggested identifiers. At step 508, smart ID generator 106 sends a notification to the user via an e-mail informing the user that smart ID generator 106 has received suggested identifiers for the user. The notification also includes a link to the registration page prompting the user to register for another network application provided by network application provider 102. If the user has an e-mail account with network application provider 102, the notification is sent to an e-mail address of the user corresponding to this e-mail account. Alternatively, if the user is not registered with network application provider 102 for any network applications, the notification is sent to an e-mail address associated with other network application providers 118. In some embodiments, the notification may further include the suggested identifiers. The user may then access the registration page and begin the registration process as described earlier in conjunction with FIG. 2.

FIGS. 6A and 6B illustrate example user registration pages in accordance with one embodiment of the present invention. FIG. 6A illustrates a user registration form 600 for registering for network applications hosted by network application provider 102 according to one embodiment. User registration form 600 includes inputs for the user's personal information and user interest information. Text boxes 602 allow the user to input his name, including his first name and last name. The user can select his gender using drop down menu 604. Input boxes 606 allow input of the user's birth date information. Drop down menu 608 enables the user to select the country of his residence. Further, the user can specify street in text box 610. Text box 612 allows the input of the postal code. Though in the example mentioned above, the address may be specified using multiple fields, a person skilled in the art will recognize that the registration page may include a single field corresponding to the user's address. In one embodiment, some fields may be mandatory such as name, gender and alternate email address. Other fields, such as address and phone numbers, may be optional.

Registration form 600 may further include additional fields, for example fields 614-622, to enable the user to enter various other inputs required for completing the registration process. Text box 614 is used for inputting the user ID desired by the user and text boxes 616 are provided for entering the user's desired password for the network application. Text box 618 is used for entering an alternate email address of the user. This email address is used for communicating to the user in the case that the user forgets his user ID or password of the network application. In an embodiment, network application provider 102 sends an email to the user's alternate email address, specifying the user's user ID and password, if the user requests for his log-in information. The request for log-in information is authenticated by a secret question selected by the user during user registration, via drop down menu 620, and a secret answer provided by the user during user registration via text box 622.

Inputs 624 allow the user to input user interest information, such as keywords and brand names desired in the user ID. The user enters the desired keywords in text box 626. Registration form 600 further includes drop down menu 628 presenting a predetermined list of brand advertising keywords. The user can select desired brand advertising keywords. In an alternate embodiment, registration form 600 may include a text box 628, similar to text box 626, where the user may enter the desired brand advertising keywords. In addition, registration form 600 includes a check box 630 to enable the user to opt to prompt his contacts for suggested identifiers. The user can then trigger smart ID generator 106 to generate candidate identifiers by clicking on button “Check availability” 632. In some embodiments, inputs 624 may be optional, and the user may opt to not populate them.

After checking the availability of the generated candidate identifiers, smart ID generator 106 displays the available identifiers to the user in a separate web page according to one embodiment, as illustrated in FIG. 6B. In one embodiment, the list of available candidate user IDs may be clustered in separate categories based on type of uses, for example, professional identifiers 634 and personal identifiers 636. In addition, available identifiers received as suggestions from the user's contacts may also be indicated separately as shown by group 638. In some embodiments, other criteria may be applied for clustering. For example, the clusters may be formed depending on network applications, such as anonymity identifiers, instant messenger identifiers and so on. The present invention may also present the list of available candidate user IDs without clustering them. In one embodiment, the list of available identifiers is presented with a check box associated with each presented identifier. The user may select one or more desired identifiers by clicking on corresponding check boxes. In another embodiment, smart ID generator 106 may allow the user to choose only one identifier. In this case, the identifiers may be accompanied by radio buttons to record the user's selection. If the user is not satisfied with the identifiers presented by smart ID generator 106, he may enter another identifier, by specifying it in text box 640. After selecting the desired user ID, the user clicks on “Create My Account” button 642 to complete the registration process. Smart ID generator system then provisions the selected identifier to the user. If the user has opted to try another user ID from the text box 640, smart ID generator 106 checks the user ID for availability in database 108.

The registration interfaces described above may be implemented using Common Gateway Interface script (CGI), Personal Home Page (PHP), Active Server Pages (ASP), Hyper Text Markup Language (HTML), Extended Markup Language (XML), Java and the like.

FIGS. 7A, 7B and 7C illustrate example user interfaces (UI) for the user's contacts to submit suggested identifiers for the user according to one embodiment. FIGS. 7A and 7B illustrate example UIs for making the suggestions through an instant messenger client in accordance with one embodiment. The user's contacts receive automated prompts or instant messages from network application provider 102 during the user's registration process. FIG. 7A illustrates a UI where the user's contacts submit suggestions using the instant messenger client. FIG. 7B illustrates a UI where the user's contacts are provided a link to a web interface. When the user's contacts click on the link, smart ID generator 106 presents the web interface to the user's contacts. An example web interface is illustrated in FIG. 7C according to one embodiment. The user's contact may enter one or more suggested identifiers in text box 702 and click on button “Make suggestion” to submit the suggestion.

Smart ID Generator System Architecture

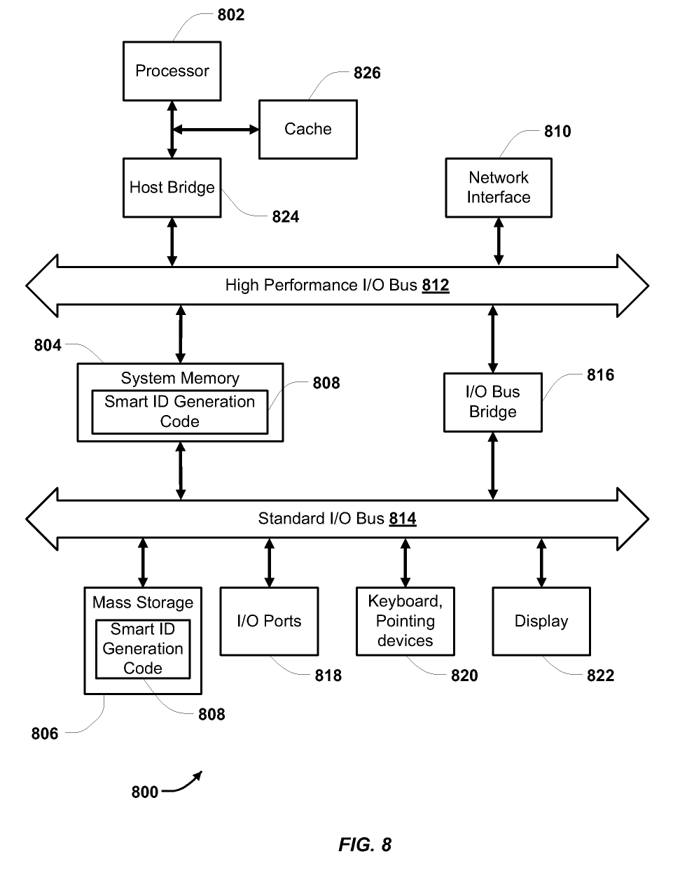

FIG. 8 illustrates an example hardware system 800 to implement smart ID generator 106 according to one embodiment. Hardware system 800 includes at least one processor 802, a system memory 804, and mass storage 806. The system memory 804 has stored therein one or more application software, programming instructions for implementing smart ID generation process 808, an operating system and drivers directed to the functions described herein. Mass storage 806 provides permanent storage for the data and programming instructions for smart ID generation process 808, whereas system memory 804 (e.g., DRAM) provides temporary storage for the data and programming instructions when executed by processor 802. The process flow of the programming instructions for smart ID generation process 808 is described in detail in conjunction with FIG. 2. In on embodiment, database 108 may reside in mass storage 806. A network/communication interface 810 provides communication between hardware system 800 and any of a wide range of networks, such as an Ethernet (e.g., IEEE 802.3) network, etc. Additionally, hardware system 800 includes a high performance input/output (I/O) bus 812 and a standard I/O bus 814. System memory 804 and network/communication interface 810 couple to bus 812. Mass storage 806 couple to bus 814. I/O Bus Bridge 816 couples the two buses 812 and 814 to each other.

In one embodiment, smart ID generation process 200 described herein is implemented as a series of software routines run by hardware system 800. These software routines comprise a plurality or series of instructions to be executed by a processor in a hardware system, such as processor 802. Initially, the series of instructions are stored on a storage device, such as mass storage 806. However, the series of instructions can be stored on any suitable storage medium, such as a diskette, CD-ROM, ROM, EEPROM, DVD, Blu-ray disk, etc. Furthermore, the series of instructions need not be stored locally, and could be received from a remote storage device, such as server on a network, via network/communication interface 810. The instructions are copied from the storage device, such as mass storage 806, into memory 804 and then accessed and executed by processor 802.

In one embodiment, hardware system 800 may also include I/O ports 818, a keyboard and pointing device 820, a display 822 coupled to bus 812. I/O ports 818 are one or more serial and/or parallel communication ports that provide communication between additional peripheral devices, which may be coupled to hardware system 800. A host bridge 824 couples processor 802 to high performance I/O bus 810. Hardware system 800 may further include video memory (not shown) and a display device coupled to the video memory. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

Hardware system 800 may include a variety of system architectures; and various components of hardware system 800 may be rearranged. For example, cache 826 may be on-chip with processor 802. Alternatively, cache 826 and processor 802 may be packed together as a “processor module,” with processor 802 being referred to as the “processor core.” Furthermore, certain embodiments of the present invention may not require nor include all of the above components. For example, the peripheral devices shown coupled to standard I/O bus 812 may couple to high performance I/O bus 810. In addition, in some embodiments only a single bus may exist with the components of hardware system 800 being coupled to the single bus. Furthermore, hardware system 800 may include additional components, such as additional processors, storage devices, or memories.

An operating system manages and controls the operation of hardware system 800, including the input and output of data to and from software applications (not shown). The operating system provides an interface between the software applications being executed on the system and the hardware components of the system. According to one embodiment of the present invention, the operating system is the LINUX operating system. However, the present invention may be used with other suitable operating systems, such as the Windows® 95/98/NT/XP/Server operating system, available from Microsoft Corporation of Redmond, Wash., the Apple Macintosh Operating System, available from Apple Computer Int. of Cupertino, Calif., UNIX operating systems, and the like.

The present invention has been explained with reference to specific embodiments. For example, while embodiments of the present invention have been described with reference to specific hardware and software components, those skilled in the art will appreciate that different combinations of hardware and/or software components may also be used, and that particular operations described as being implemented in hardware might also be implemented in software or vice versa. Other embodiments will be evident to those of ordinary skill in the art. It is therefore not intended that the present invention be limited, except as indicated by the appended claims.

1. A method for recommending one or more personalized identifiers for a user, the method comprising:
receiving, at a server, personal information of a user;
receiving, at the server, information related to the user's interests;
generating a list of candidate identifiers taking into account the personal information and the information related to the user's interests;
checking availability of each identifier in the list of candidate identifiers using a database; and
providing a list of available identifiers to the user, wherein the list of available identifiers comprises one or more available identifiers from the list of candidate identifiers.

2. The method of claim 1, wherein the personal information comprises one or more of a first name, a last name, a gender, a postal code, and an address.

3. The method of claim 1, wherein the information related to user interests comprises one or more of:
a. one or more user specified keywords;
b. one or more brand advertising keywords;
c. one or more dictionary terms;
d. one or more thesaurus terms;
e. one or more buzz terms;
f. one or more property based keywords.

4. The method of claim 1, wherein one or more identifiers of the candidate identifiers are one of: a user identity (ID), a screen name, an email address, an open ID Uniform Resource Locator (URL) and an alias name.

5. The method of claim 1 further comprising compiling, at the server, a list of suggested identifiers for the user using inputs received from one or more contacts of the user.

6. The method of claim 1 further comprising clustering the list of available identifiers into one or more clusters based on a category of the identifier.

7. The method of claim 6, wherein the category of the identifier is selected from a group consisting of a personal category and a professional category.

8. A method for recommending one or more personalized identifiers, the method comprising:
compiling, at a server, a list of suggested identifiers for a user using inputs received from one or more contacts of the user;
checking availability of each identifier in the list of suggested identifiers using a database; and
providing a list of available suggested identifiers to the user, wherein the list of available suggested identifiers comprises one or more available identifiers from the list of suggested identifiers.

9. The method of claim 8 further comprising providing a web interface to the one or more contacts of the user for inputting at least one suggested identifier.

10. The method of claim 8 further comprising obtaining contact details of the one or more contacts of the user from the user's address book.

11. The method of claim 8 further comprising retrieving contact information for the one or more contacts of the user from an address book maintained by the user.

12. The method of claim 8 further comprising checking online availability of the one or more contacts of the user.

13. The method of claim 12 further comprising prompting at least one online contact of the user to input at least one suggested identifier.

14. The method of claim 8 further comprising prompting the one or more contacts of the user via an instant messaging system for inputting at least one suggested identifier.

15. The method of claim 14 further comprising receiving the at least one suggested identifier via the instant messaging system.

16. The method of claim 8, wherein the user selects at least one contact to be prompted for suggested identifiers.

17. A system for recommending one or more personalized identifiers, the system comprising:
one or more network interfaces;
at least one processor;
a memory; and
computer program code stored in a computer readable storage medium, wherein the computer program code, when executed, is operative to cause the at least one processor to:
obtain a user's personal information;
obtain information related to the user's interests;
generate a list of candidate identifiers taking into account the personal information and the information related to the user's interests;
check availability of each identifier in the list of candidate identifiers using a database; and
provide a list of available identifiers to the user, wherein the list of available identifiers comprises one or more available identifiers from the list of candidate identifiers.

18. The system of claim 17, wherein the user's personal information comprises one or more of a first name, a last name, a gender, a postal code, and an address.

19. The system of claim 17, wherein the information related to the user's interests comprises one or more of:
a. one or more user specified keywords;
b. one or more brand advertising keywords;
c. one or more dictionary terms;
d. one or more thesaurus terms;
e. one or more buzz terms;
f. one or more property based keywords.

20. A computer program product comprising a computer readable medium encoded with computer-executable instructions for recommending one or more personalized identifiers, the computer-executable instructions, when executed, operable to cause one or more processors to:
obtain a user's personal information;
obtain information related to the user's interests;
generate a list of candidate identifiers taking into account the personal information and the information related to the user's interests;
check availability of each identifier in the list of candidate identifiers using a database; and
provide a list of available identifiers to the user, wherein the list of available identifiers comprises one or more available identifiers from the list of candidate identifiers.
